(19) United States
(12) Patent Application Publication
(10) Pub. No.: US 2010/0314820 A1
(43) Pub. Date: Dec. 16, 2010

(54) DOCUMENT OBFUSCATION APPARATUS AND SYSTEMS

(75) Inventor: JOSEPH Y. KO, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(73) Assignee: TECHKO, INC., Laguna Hills, CA (US)

(21) Appl. No.: 12/484,074

(22) Filed: Jun. 12, 2009

(51) Int. Cl. B65H 39/00; B65H 3/06; B41L 19/00

(52) U.S. Cl. 270/58.08; 271/109; 101/45

(57) ABSTRACT

Document obfuscation devices and systems are disclosed for obfuscating paper documents so as to prevent dissemination of sensitive information without shredding in order to increase recycling potential. Certain obfuscation devices include a pair of rollers, at least one of which is imprinted with an obfuscation pattern, and a mechanism for feeding sheets of paper through the pair of rollers. Certain obfuscation systems include an obfuscation device and a recycle bin coupled together.

### BACKGROUND

1. Field

Embodiments of the invention generally relate to preventing distribution of information and, in particular, to apparatus and methods for obfuscating information contained on documents.

2. Description of the Related Art

Shredding devices are often used to shred documents containing confidential or sensitive information in order to prevent its dissemination. However, shredding the paper can reduce the recycling potential of the paper and make the recycling process more difficult. Moreover, highly motivated people can take a shredded document and painstakingly reassemble it to determine its original content.

For example, the recycling potential of paper can be determined by the length of the individual paper fibers contained within the piece of paper. A longer fiber can be used to produce higher-grade recycled paper and can be recycled many more times than a shorter fiber. When paper is shredded in conventional shredders, such as cross-cut shredders, the individual paper fibers are cut into very small lengths, thus reducing the paper's recycling potential.

In addition, the small shredded bits of paper can slip through the small openings of the sifting screens used at recycling facilities to separate out the non-recyclable contaminants from the recyclable material. Furthermore, many contaminants can “hide” in the clumps of shredded paper, such as bits of plastic, metal or glass. These hidden contaminants, which do not get separated out from the recyclable paper, can cause serious damage to the recycling machines and reduce the quality of the recycled paper produced.

### SUMMARY

In view of the foregoing, a need exists for devices that protect against dissemination of sensitive information on documents but still maintain a high level of recyclability. Moreover, there is a need for systems and methods that simplify the recycling process for paper documents with sensitive information.

In certain embodiments, such systems and methods can be used to conceal sensitive information on paper documents without shredding the paper documents. The systems and methods can obfuscate the text of the paper documents by sending the paper documents through at least one ink roller imprinted with an obfuscation pattern composed of random symbols. In certain embodiments, the pattern of random symbols, when stamped on the document, renders the underlying text unreadable and/or unable to be reproduced.

In certain embodiments, a consumer-sized obfuscation device is disclosed for concealing sensitive information on a sheet of paper without shredding. The obfuscation device includes a pair of rollers, one or both of which can be engraved or embossed with an obfuscation pattern. The obfuscation device also includes at least one removable and/or replaceable ink cartridge adjacent to at least one of the rollers. The ink cartridge(s) can include an ink application portion that is exposed to an outer surface of the ink roller and that applies ink to the ink roller via direct contact as the ink roller rotates about a central axis. The obfuscation device further includes a housing enclosing the ink roller(s) and the ink cartridge(s) and a paper feed tray attached to the housing that is configured to receive at least one document to be obfuscated.

In certain embodiments, a system is disclosed for concealing sensitive information on a sheet of paper without shredding the paper. The system includes a consumer-sized obfuscation device and a recycle bin. The consumer-sized obfuscation device includes at least one ink roller having an obfuscation pattern imprinted thereon; at least one ink cartridge adjacent to the ink roller; a housing enclosing the ink roller and the ink cartridge; and a paper feed tray attached to the housing. The recycle bin is configured to receive multiple obfuscated sheets of paper output from the obfuscation device. The recycle bin includes a bottom portion sized to receive the multiple sheets of paper and multiple binding members extending from the bottom portion sized and configured to bind the obfuscated sheets of paper in an organized bundle for delivery.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a front perspective view of an automatic feed document obfuscation device with a portion of the housing removed, according to certain embodiments of the invention.

FIG. 2 illustrates a cross-sectional view of the document obfuscation device of FIG. 1.

FIG. 3A illustrates a side view of an exemplary embodiment of an ink roller usable with the obfuscation device of FIG. 1.

FIG. 3B illustrates a magnified view of an exemplary embodiment of a surface portion of the ink roller of FIG. 3A.

FIGS. 4A and 4B illustrate a document before and after being fed through the obfuscation device of FIG. 1.

FIG. 5 illustrates a front perspective view of an electric document obfuscation device with a portion of the housing removed, according to certain embodiments of the invention.

FIG. 6 illustrates a cross-sectional view of the electronic document obfuscation device of FIG. 5.

FIG. 7 illustrates a front perspective view of a manual feed document obfuscation device with a portion of the housing removed, according to certain embodiments of the invention.

FIG. 8 illustrates a document obfuscation and recycling system, according to certain embodiments of the invention.

FIG. 9A illustrates a perspective view of a recycle bin before being opened for use, according to certain embodiments of the invention.

FIG. 9B illustrates a perspective view of the recycle bin of FIG. 9A after being opened for use.

FIG. 9C illustrates a perspective view of the recycle bin of FIGS. 9A and 9B loaded with multiple obfuscated documents.

### DETAILED DESCRIPTION OF THE PREFERRED EMBODIMENTS

Embodiments of the invention include devices and systems for obfuscating sensitive information on paper documents while still maintaining a high degree of recyclability. In particular, certain embodiments include one or more ink rollers imprinted with a pattern of symbols to conceal the sensitive or confidential information. In certain embodiments, the high degree of recyclability is maintained due to the fact that the long, individual paper fibers of the paper documents are not shredded.

In certain embodiments, obfuscation devices disclosed herein comprise consumer-sized obfuscation devices that include an auto feed feature configured to hold a stack of multiple sheets of paper and to consecutively advance the multiple sheets of paper from the stack to the ink rollers. In other embodiments, the obfuscation devices include a manual feed mechanism for advancing a sheet of paper without the need for electric power. In certain embodiments, the obfuscation devices disclosed herein are sized such that they are portable and easily transported.

The features of the devices and systems will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

In addition, any methods and functions described herein are not limited to any particular sequence, and the acts relating thereto can be performed in other sequences that are appropriate.

The term “consumer-sized” as used herein is a broad term and is used in its ordinary sense and is used, without limitation, to describe apparatus, devices, systems, and the like, that are generally used in a home or office setting.

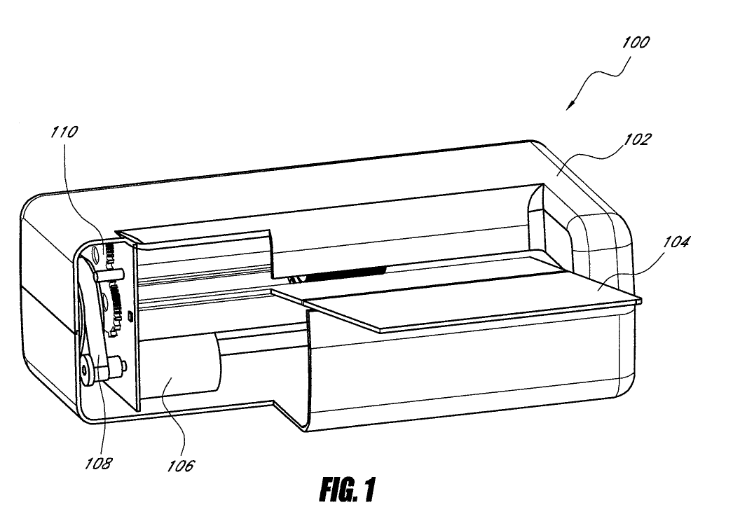

FIG. 1 illustrates a front perspective view of an auto feed document obfuscation device 100, according to certain embodiments of the invention. As shown, the auto feed obfuscation device 100 includes a housing 102, a paper feed tray 104, a drive motor 106, a drive belt 108 and drive gears 110. For ease of explanation and illustration, a portion of the housing 102 has been removed.

The auto feed document obfuscation device 100 includes an auto feed feature for automatically feeding multiple sheets of paper or other documents into the auto feed document obfuscation device 100 one at a time. As illustrated, the paper feed tray 104 is positioned at the front end of the obfuscation device 100 and can be angled to sequentially direct paper material into the obfuscation device 100. For example, the paper feed tray 104 can be angled to provide a gravity-assisted feed of the sheets of paper to be obfuscated.

In certain embodiments, the paper feed tray 104 is sized to support paper having dimensions ranging from approximately 8.5 inches by eleven inches (letter size) to approximately 8.5 inches by fourteen inches (legal size). In other embodiments, the paper feed tray 104 is sized to support paper having any other smaller or larger dimensions. In certain embodiments, the paper feed tray 104 further includes adjustable guides for the feeding of paper. In certain embodiments the adjustable guides can be adjusted to accommodate paper having widths ranging from approximately three to eleven inches. In certain embodiments, the paper feed tray 104 is sized to receive a stack of approximately twenty sheets of 20-pound bond paper. In yet other embodiments, the paper feed tray 104 can be configured to hold more or less than twenty sheets, such as for example, approximately five to one hundred sheets. Moreover, if desired, markings (not shown) may be provided on the paper feed tray 104 and/or its adjustable guides to indicate the paper size and approximate height corresponding to a particular number of paper sheets.

In certain embodiments, the paper feed tray 104 can have a plurality of tabs for securing the paper feed tray 104 to the housing 102 and for allowing removal of the paper feed tray 104 during shipping. In yet other embodiments, the paper feed tray 104 can be secured to the housing 102 using screws or other conventional fasteners.

In certain embodiments, the drive motor 106 is configured to rotate the drive belt 108 and/or the drive gears 110. In certain embodiments, the drive motor 106 can be powered externally (e.g., AC power from an electrical outlet) and/or internally (e.g., battery or capacitive storage device). The drive gears 110 can include one or more individual gears configured to control rotation of one or more internal rollers within the housing 102. In some embodiments, the drive gears 110, control rotation of paper feed rollers and/or ink rollers.

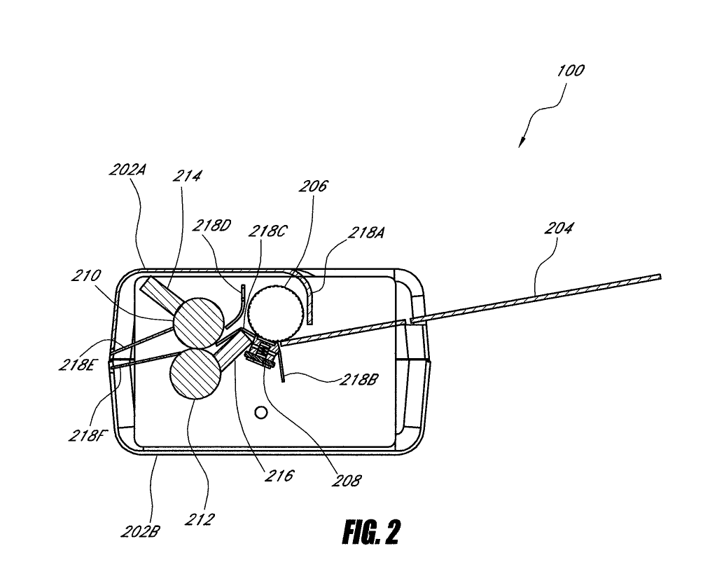

FIG. 2 illustrates a cross-sectional view of the auto feed document obfuscation device 100 of FIG. 1. In certain embodiments, the housing of the obfuscation device 100 includes an upper housing 202A and a lower housing 202B. In other embodiments, the housing can comprise a front housing and a back housing or a left housing and a right housing. In yet other embodiments, the housing can include any number of component portions configured to interface with each other to form the housing. The upper housing 202A and the lower housing 202B can be attached at various locations by any suitable means of attachment, such as snap-fit members fasteners, screws, adhesive, glue, combinations of the same and the like. In certain embodiments, the upper housing 202A and the lower housing 202B can be separated and reattached, thereby allowing access for maintenance, replacement, and/or cleaning purposes. Moreover, in certain embodiments, the housing can comprise an exit slot through which the obfuscated documents exit the device 100, For instance, in certain embodiments, the exit slot can be positioned toward an edge and/or bottom portion of the housing such that obfuscated documents can directly pass to a waste receptacle and/or be manually removed.

In certain embodiments, the obfuscation device 100 includes an auto feed tray 204, an auto feed roller 206, an auto feed assembly 208, an upper ink roller 210, a lower ink roller 212, an upper ink cartridge 214, and a lower ink cartridge 216. In certain embodiments, the auto feed tray 204 is coupled to the upper housing 202A via a pivot assembly (not shown) and is advantageously configured to fold into the upper housing 202A, such as during transportation and/or non-operation. In such embodiments, the folded auto feed tray 204 can advantageously protect the auto feed assembly 208 and the auto feed roller 206 and/or prevent material from entering into the housing. In yet other embodiments, the auto feed tray 204 can slide at least partially within the upper housing 202A. In still other embodiments, the auto feed tray 204 can be secured to the upper housing 202A using conventional fasteners in a substantially permanent position.

The auto feed assembly 208 is positioned near the bottom of the auto feed tray 204 for advancing sheets of paper placed on the auto feed tray 204. For example, the auto feed assembly 208 can comprise a spring-type engagement that causes a contact member of the auto feed assembly 208 to exert sufficient pressure against the paper in the auto feed tray 204 so as to advance multiple sheets of paper one at a time during rotation of the auto feed roller 206.

The auto feed roller 206 is configured to consecutively advance multiple sheets of paper from the auto feed tray 204 to the ink rollers 210, 212. In certain embodiments, the external surface of the auto feed roller 206 can advantageously be grooved or otherwise textured so as to provide better grip for advancing sheets of paper. For example, the auto feed roller 206 can include a plurality of spikes disposed around a circumference of the auto feed roller 206. In yet other embodiments, the auto feed roller 206 can comprise protrusions, knobs or other like features for sequentially advancing documents in the auto feed tray 204. In certain embodiments, the auto feed roller 206 is coupled to a rotatable member in the form of an elongated shaft. The rotatable member can be driven, for example, by the drive motor 106 and the drive gears 110 of FIG. 1.

In certain embodiments, to utilize the auto feed feature of the auto feed document obfuscation device 100, a user places a stack of paper in the auto feed tray 204. Because the auto feed tray 206 is slightly angled toward the auto feed document obfuscation device 100, the stack of paper can naturally gravitate toward the auto feed assembly 208. As the auto feed roller 206 rotates, the auto feed assembly 208 secures a sheet of paper from the stack of paper and advances the sheet into the device to be “stamped,” or obfuscated, by the ink rollers 210, 212. Once the sheet has been advanced passed the auto feed assembly 208, the auto feed assembly 208 secures and advances a subsequent sheet from the stack of paper. This process can continue with the auto feed assembly 208 sequentially securing and advancing individual sheets of paper until the entire stack of paper has been obfuscated. As can be seen, interaction by a user during the auto feed obfuscation process is primarily limited to placing the input stack of paper in the auto feed tray 204. In certain embodiments, the auto feed assembly 208 automatically initiates the auto feed process upon detection of paper within the auto feed tray 206. In other embodiments, a user can initiate the auto feed process via a user input, such as a button or switch.

The upper ink roller 210 and the lower ink roller 212 are configured to receive the sheets of paper fed by the auto feed roller 206 and to cover at least a portion of the paper with an obfuscation pattern in order to effectively conceal sensitive information located thereon. In certain embodiments, the ink rollers 210, 212 are configured to cover the entire face of the document with the obfuscation pattern. The upper ink roller 210 and the lower ink roller 212 are coupled to drive gears 110, which effect rotation of the ink rollers 210, 212. The ink rollers 210, 212 can be coupled to the drive gears 110 via a rotatable member. In some embodiments, the rotatable member comprises an elongate shaft that extends through the central axis of the ink roller. In other embodiments, the rotatable member comprises a projection on the end of the ink roller that is configured to be engaged by the drive gears 110.

In certain embodiments, the auto feed roller 206 is rotatably coupled to one or more of the ink rollers 210, 212 (for example, via drive belt 108 and drive gears 110) such that rotation of the ink rollers 210, 212 is synchronized with rotation of the auto feed roller 206. In other embodiments, rotation of the auto feed roller 206 operates independently of the rotation of the ink rollers 210, 212.

In certain embodiments, the upper ink cartridge 214 and the lower ink cartridge 216 each comprise an ink application portion, such as an ink pad or brush, at one end that is positioned to apply ink to at least one of the ink rollers. For example, the ink application portion can brush up against, or make other direct contact with, an outer surface of a respective ink roller to apply a coat of ink as the ink roller rotates about its central axis. In certain embodiments, the ink application portion can supply droplets of ink to the external surface of an ink roller as it rotates. In other embodiments, the ink cartridges 214, 216 are placed within their respective ink rollers and are configured to transfer ink from the inside to an outside surface of the respective ink roller. In certain embodiments, the ink application portions of the upper ink cartridge 214 and the lower ink cartridge 216 can be comprised of foam, a brush, padding, sponge, and/or other suitable application material. For example, foam ink application portions can be formed of rubber foam, such as polyurethane foam or natural foam rubber latex. In some embodiments, the ink cartridges 214, 216 directly and continuously contact their respective ink rollers. In other embodiments, the ink cartridges 214, 216 are configured to move slightly away from their respective ink rollers when not in use. In yet other embodiments, the ink application portion can comprise a rotatable portion that rotates to apply ink to the outer surface of an ink roller (e.g., during rotation of the ink roller).

In some embodiments, the ink cartridges 214, 216 can be sized proportionate to their respective ink rollers. In other embodiments, each of the ink cartridges 214, 216 can be substantially smaller than its respective ink roller but can be configured to move laterally along the outer surface of its respective ink roller in a direction aligned parallel with the longitudinal axis of the respective ink roller, similar to movement of a printer head during printing.

In certain embodiments, the upper ink roller 210 and the lower ink roller 212 can be sized so as to at least substantially cover the inserted sheets of paper with the obfuscation pattern. In other embodiments, the upper ink roller 210 and the lower ink roller 212 can have a length substantially shorter than the width of the paper. Accordingly, in certain embodiments, the upper ink roller 210 and the lower ink roller 212 are moveable within the document obfuscation device 100 so as to provide coverage of selected portions of the document and/or to provide coverage via multiple passes. The shorter ink rollers can advantageously allow the document obfuscation device 100 to apply ink only to selected portions of a document. For example, a document may only have text on a small portion of the document. In such embodiments, the shorter ink rollers can be used to conserve the ink supply.

In certain embodiments, the document obfuscation device 100 can include one or more sensors configured to detect the presence of informational content on one or both sides of a document, thereby enabling the document obfuscation device 100 to only apply ink to the informational content. In other embodiments, the document obfuscation device 100 can operate in conjunction with a scanner to aid in detecting the presence of information content to be obfuscated.

In certain embodiments, the upper ink cartridge 214 and the lower ink cartridge 216 are removable and can be replaced with replacement cartridges when empty. In other embodiments, the upper ink cartridge 214 and the lower ink cartridge 216 can be removed, refilled with fresh ink and then reinserted into position. For example, the upper ink cartridge 214 and the lower ink cartridge 216 can slide in and out of position along a track and be snapped into place. In still other embodiments, the document obfuscation device 100 can include an ink reservoir (not shown) configured to supply the ink cartridges 214, 216 with additional ink by means of tubes or the like. In some embodiments, the auto feed document obfuscation device 100 includes one or more sensors to indicate the level of ink remaining in each of the ink cartridges 214, 216. In certain embodiments, the ink cartridges 214, 216 can be filled with black ink. In other embodiments, one or more of the ink cartridges 214, 216 can be filled with ink of other dark colors. Preferably, the ink used in the ink cartridges 214, 216 does not adversely affect the recycling potential of the paper. In certain embodiments, the ink used contains properties that enhance separation from the paper during the recycling process.

Although FIG. 2 illustrates two ink rollers and two ink cartridges, in certain embodiments, the document obfuscation device 100 can include a single ink cartridge and/or a single ink roller. In embodiments having a single ink cartridge, the ink cartridge can be configured to supply ink to one or both ink rollers.

FIG. 2 also illustrates several paper guides (collectively 218) positioned to guide the sheets of paper as they are fed through the obfuscation device 100. A front paper guide 218A is positioned above the auto feed tray 204. In certain embodiments, the front paper guide 218A rests on top of paper placed in the auto feed tray 204 to prevent the paper from substantial lateral movement and/or to reduce paper movement noise. The front paper guide 218A can also advantageously prevent unwanted items from entering the auto feed tray 204 and/or function as a safety guard (e.g., for preventing children from touching the auto feed assembly 208 and/or auto feed roller 206). The front paper guide 218A can also limit the number of sheets of paper to be stacked on the auto feed tray 204 at any given time. In yet other embodiments, the obfuscation device 100 can function without the front paper guide 218A.

Internal paper guides 218B, 218C and 218D are configured to guide the paper from the auto feed roller 206 into the ink rollers 210, 212. The internal paper guides 218B-218D can also advantageously prevent paper jams. Rear paper guides 218E, 218F can guide the paper from the ink rollers 210, 212 and out of the document obfuscation device 100. In certain embodiments, the rear paper guides 218E, 218F can guide the paper into a receiving tray or recycle bin (not shown) located either internal or external to the document obfuscation device 100.

In certain embodiments, sensing technology can be used for detecting the insertion of paper and can include, for example, touch sensors, switches, triggers, or the like. For example, the sensing technology can comprise photo sensors placed near the throat of the auto feed tray 204.

In certain embodiments, the auto feed obfuscation device 100 can have additional electronic features for improving the safety and functionality of the obfuscation device 100. For instance, the obfuscation device 100 can further include an overload detection function that determines when the auto feed roller 206 and/or the ink rollers 210, 212 are jammed or are otherwise drawing excessive current due to material accumulated therein. Upon detecting an overload, the obfuscation device 100 can automatically stop rotation of the auto feed roller 206 and/or the ink rollers 210, 212. In yet other embodiments, the obfuscation device 100 can reverse the rotation of the auto feed roller 206 and ink rollers 210, 212 so as to dislodge material causing the overload condition.

In certain embodiments, the auto feed document obfuscation device 100 can further include an overheat detection function that determines when the temperature of the drive motor 106 has reached a threshold amount. Upon detecting overheating, the auto feed document obfuscation device 100 can automatically suspend rotation of the auto feed roller 206 and/or the ink rollers 210, 212.

In certain embodiments, the document obfuscation device 100 can include a self-cleaning feature configured to, for example, remove particulate matter and/or prevent hardening or buildup of dry ink on the ink rollers 210, 212 and/or on the ink application portions of the ink cartridges 214, 216. In certain embodiments, a self-cleaning assembly can comprise one or more air hoses and/or vacuum means to remove particulate paper and/or ink matter. In other embodiments, a self-cleaning assembly comprises a reservoir of cleaning fluid (e.g., ammonia) that can be supplied to the outer surfaces of the ink roller(s) by a tube or other like delivery means.

In certain embodiments, one or more of the above-disclosed safety functions can be controlled through an integrated circuit (not shown) on the auto feed document obfuscation device 100. Moreover, the auto feed document obfuscation device 100 can further include a user interface for alerting the user to various device conditions. For example, the auto feed document obfuscation device 100 can include one or more light emitting diodes (LEDs), a display screen, or the like. The user interface can also include one or more input devices, such as buttons, switches, and/or a touch screen display. In certain embodiments, a user can select the size of the paper to be inserted, select single- or double-sided obfuscation, select portions of the document to be obfuscated, select an obfuscation pattern and/or the like via the input devices.

In certain embodiments, only the upper ink roller 210 is imprinted with the obfuscation pattern and the lower ink roller 212 is a smooth roller without an obfuscation pattern. It should be appreciated that, in the embodiment where the lower ink roller 212 is a smooth roller without any obfuscation pattern, the lower ink cartridge 216 can be absent.

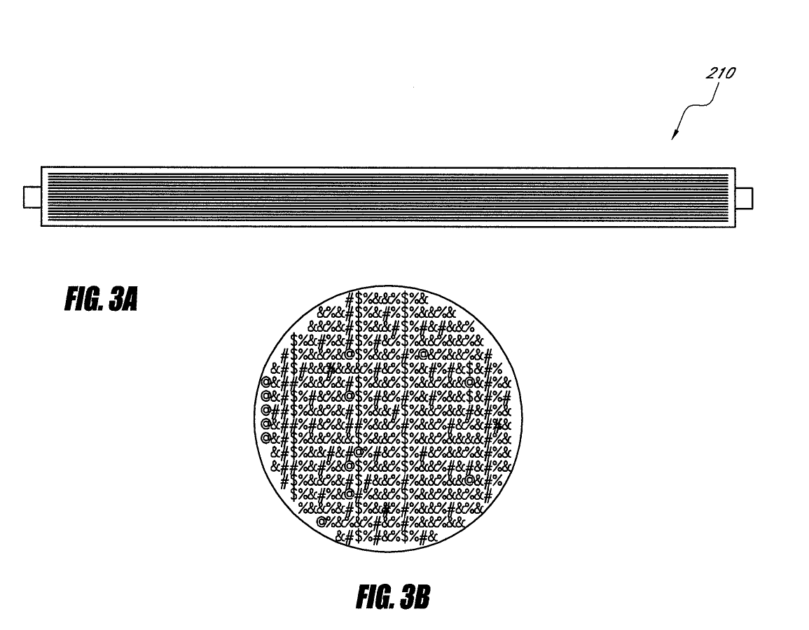

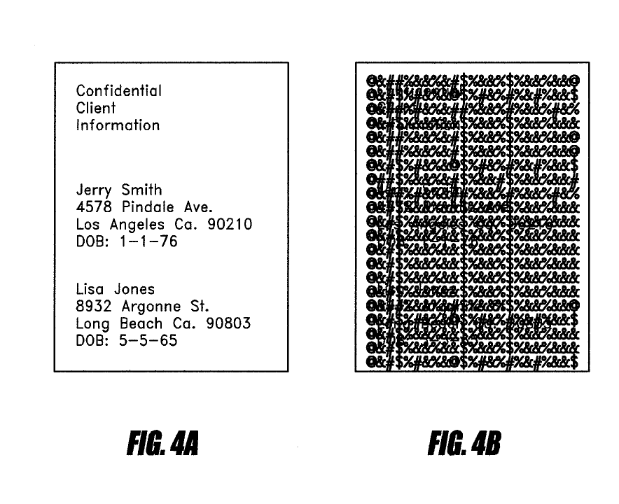

FIG. 3A illustrates a front view of the upper ink roller 210, according to certain embodiments of the invention. As shown in the magnified view of FIG. 3B, an outer surface of the upper ink roller 210 can be imprinted, embossed, engraved and/or otherwise at least partially covered with a pattern of symbols or marks designed to obfuscate the sensitive content of paper documents. In some embodiments, substantially the entire face of the document is covered with the obfuscation pattern, regardless of its content. In other embodiments, only selected portions of the document are covered with the obfuscation pattern.

FIG. 3B illustrates an exemplary embodiment of a pattern comprised entirely of symbols. In certain embodiments, both the upper ink roller 210 and the lower ink roller 212 are imprinted with an obfuscation pattern so as to simultaneously obfuscate the content on both sides of a sheet of paper. In other embodiments, only the upper ink roller 210 is imprinted with the obfuscation pattern. The obfuscation pattern can include any combination of letters, numbers, symbols, and/or marks and should not be limited to the particular pattern illustrated in FIG. 3B. In certain embodiments, the upper ink roller 210 and/or lower ink roller 212 can comprise a foam-like roller without a pattern configured to apply a solid layer of ink to a sheet of paper.

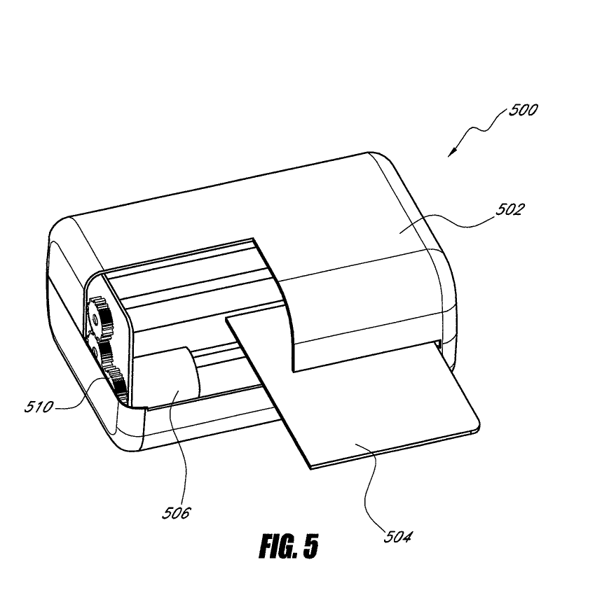

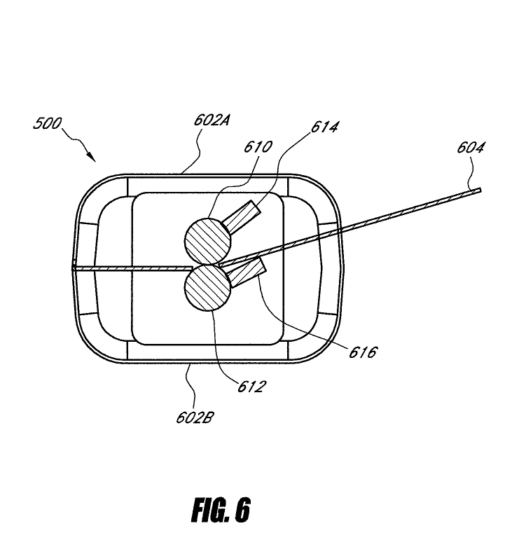

FIGS. 4A and 4B illustrate a sheet of paper before and after being fed through the obfuscation device 100. As shown, the content of the sheet of paper is obfuscated in such a manner that it cannot be deciphered, thereby preventing the dissemination of confidential or sensitive information.

FIG. 5 illustrates a front perspective view of an electric document obfuscation device 500, in accordance with embodiments of the invention. In certain embodiments, the obfuscation device 500 can be similar in structure and/or function to the obfuscation device 100 of FIG. 1. The electric obfuscation device 500 can be an electric-powered device that is configured to advance and obfuscate sheets of paper one at a time but does not include an auto feed feature. As illustrated, the obfuscation device 500 comprises a housing 502, a paper tray 504, a drive motor 506 and drive gears 510. For ease of explanation and illustration, a portion of the housing 502 has been removed. In certain embodiments, the obfuscation device 500 can be powered externally, such as by AC power. In other embodiments, the obfuscation device 500 can be powered internally, such as by a battery or capacitive storage device.

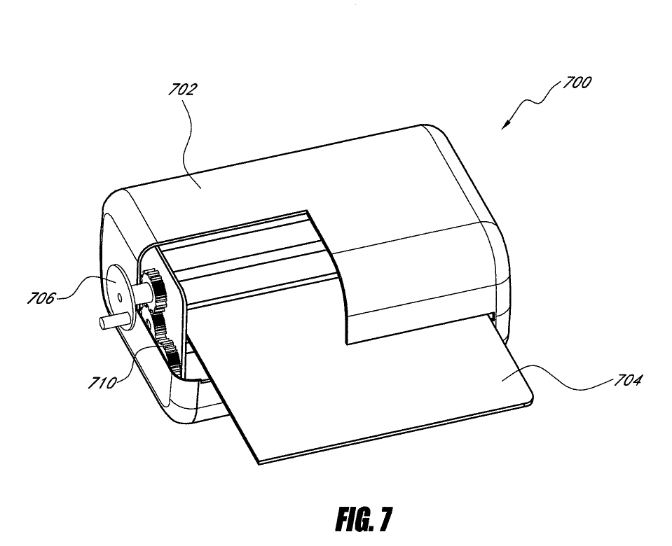

FIG. 6 illustrates a cross-sectional view of the obfuscation device 500. As shown, the obfuscation device includes an upper housing 602A, a lower housing 602B, a paper tray 604, an upper ink roller 610, a lower ink roller 612, an upper ink cartridge 614 and a lower ink cartridge 616. In certain embodiments, the upper ink roller 610 and the lower ink roller 612 are driven by the drive motor 506 in conjunction with the drive gears 506. The drive motor 506 controls the speed of rotation of the rollers and can configure the rotation such that ink is applied evenly across the entire sheet of paper as it is fed through the rollers. In certain embodiments, both the upper ink roller 610 and the lower ink roller 612 are imprinted with an obfuscation pattern. In other embodiments, only the upper ink roller 610 is imprinted with an obfuscation pattern and the lower ink roller 612 comprises a smooth roller.

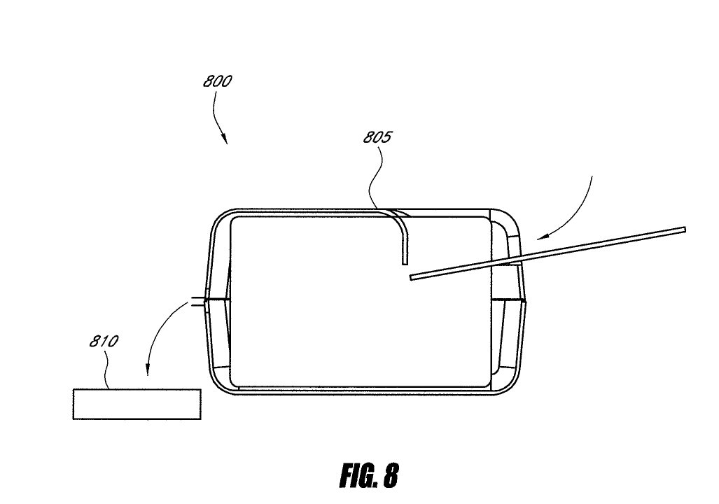

FIG. 7 illustrates a front perspective view of a manually-operated document obfuscation device 700, according to embodiments of the invention. In certain embodiments, the manually-operated obfuscation device 700 can be similar in structure and/or function to the electric obfuscation device 500 of FIG. 5. For example, the internal components of the manually-operated obfuscation device 700 can be substantially similar to the internal components of the electric obfuscation device 500 shown in FIG. 6. It should be appreciated, however, that the manually-operated obfuscation device 700 does not require an electric motor.

As shown, the manual feed obfuscation device 700 includes a housing 702, a paper tray 704, a hand crank 706 and drive gears 710. For ease of explanation and illustration, a portion of the housing 702 has been removed. In certain embodiments, the hand crank 706 must be rotated manually in order to drive the drive gears 710, which in turn drive the rotation of the ink rollers located within the housing 702. The ink rollers can be coupled to the drive gears 710 via a rotatable member, such as an elongate shaft extending through the ink rollers or a short projection extending from the end of each of the ink rollers. In certain embodiments, the manual feed obfuscation device 700 is completely manually operated and does not require an external or internal power supply.

In certain embodiments, a document obfuscation device can combine features of the auto feed, electrical and manual obfuscation devices described above. For example, a document obfuscation device can include a hand crank for manual operation and an electric feed mechanism for automatic operation. In other embodiments, a document obfuscation device can be used in combination with a shredding device or other piece of office equipment.

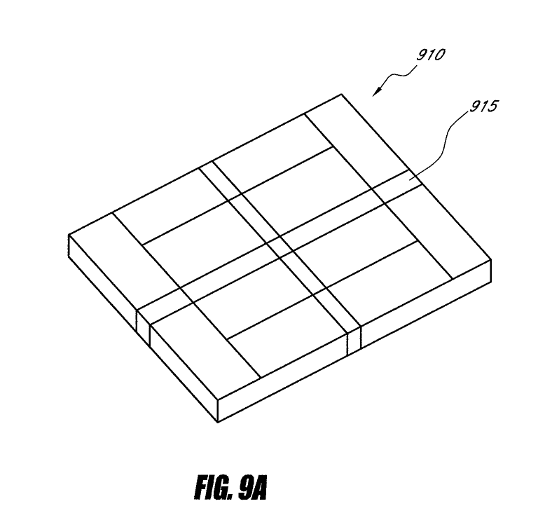

FIG. 8 illustrates a document obfuscation and recycling system 800, in accordance with embodiments of the invention. As shown, the document obfuscation system 800 includes a document obfuscation device 805 and a recycle bin 810. The document obfuscation device 805 can be similar in structure and/or function to the obfuscation devices of FIGS. 1, 5 and/or 7. The recycle bin 810 can be configured to receive multiple sheets of obfuscated paper for storage and subsequent delivery to a recycling center.

In certain embodiments, the recycle bin 810 can be externally coupled to the document obfuscation device 805. For example, the recycle bin 810 can be placed on an external receiving tray of the document obfuscation device 805. In other embodiments, the recycle bin 810 can be placed adjacent to the document obfuscation device 805 such that the obfuscated paper falls into the recycle bin 810 upon exit. In still other embodiments, a user can simply place the obfuscated paper output from the document obfuscation device 805 into the adjacent recycle bin.

In certain embodiments, the recycle bin 810 can be placed internally within the housing of the document obfuscation device 805. For example, the obfuscated document can be guided using paper guides into an internal recycle bin located beneath the ink rollers. The internal recycle bin could be accessed via a side access panel or a drawer compartment that slides in and out. In certain embodiments, the document obfuscation and recycling system 800 can comprise at least one sensor for detecting when the recycle bin 810 reaches a full state. In certain embodiments, multiple sensors are used to verify that a single sensor does not prematurely output a recycle bin full signal. It should be appreciated that other embodiments of the document obfuscation and recycling system 800 can be contemplated without departing from the scope and spirit of the disclosure.

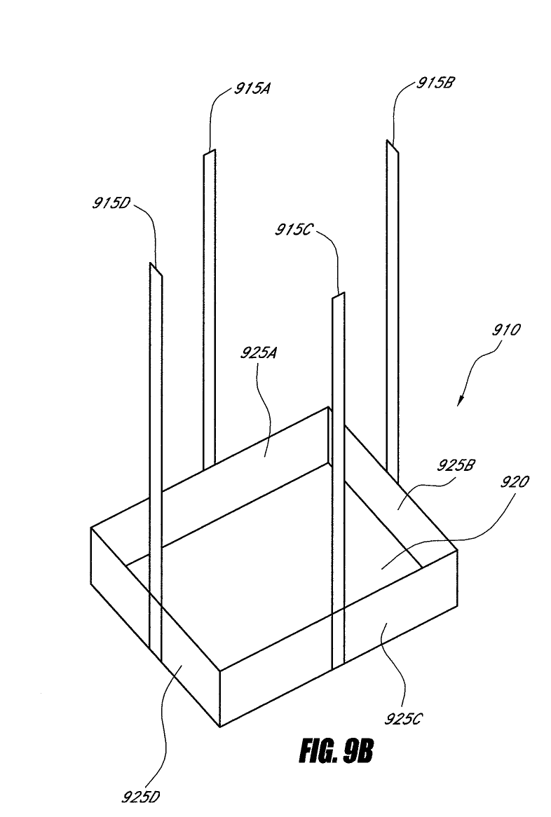

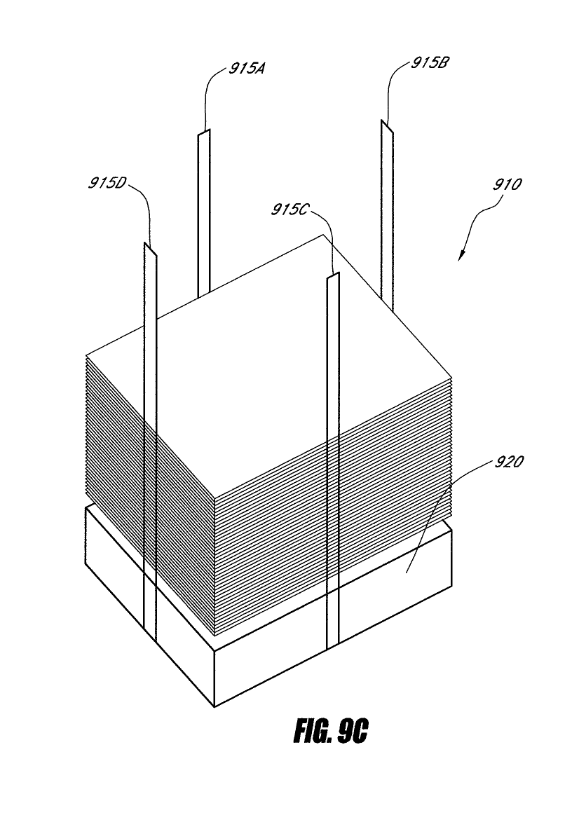

FIGS. 9A, 9B and 9C illustrate a recycle bin 910, in accordance with embodiments of the invention. FIG. 9A illustrates a recycle bin 910 before being opened for use. The recycle bin 910 can be folded up so that it is compact and sturdy during shipment. As shown, the recycle bin 910 comprises one or more binding members 915. The binding members 915 can comprise ropes, cords, straps or the like. The recycle bin 910 can advantageously be formed of recyclable material. In certain embodiments, the recycle bin 910 is disposable and 100% recyclable.

FIG. 9B illustrates the recycle bin 910 after being unfolded and ready for use. As shown, the recycle bin 910 includes a receptacle containing a bottom portion 920 and four flaps 925A-D extending upward from the bottom portion 920. The flaps 925A-D can be of any suitable height. In certain embodiments, the bottom portion 920 can be sized so as to accommodate letter-sized paper (8.5 by eleven inches). In other embodiments, the bottom portion 920 can be sized so as to accommodate legal-sized paper (8.5 by approximately fourteen inches). In yet other embodiments, the bottom portion 920 can be sized so as to accommodate other standard paper sizes. It should be appreciated that in some embodiments, the flaps 925A-D can be absent, such that the bottom portion 920 is substantially flat.

FIG. 9C illustrates the recycle bin 910 after being loaded with a stack of obfuscated sheets of paper. As shown, the recycle bin 910 includes four ropes or cords 915A-D configured to bind the stack of obfuscated documents when the stack has reached an appropriate height (for example, 12 inches). The ropes or cords 915 can be formed of any suitable material, such as nylon, twine, plastic, metal wire, rubber and the like. In certain embodiments, the ropes or cords 915 can be formed of a recyclable material. The ropes or cords 915 can be of any suitable length to bind the stack of documents. It should be appreciated that, because the bottom flat portion 920 of the recycle bin 910 is rectangular in shape, two of the ropes or cords 915A-D can be longer than the other two. For example, in certain embodiments, the two ropes on the longer sides 915B, 915D can be about fifty-five inches long and the two ropes on the shorter sides 915A, 915C can be about sixty inches long.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. Moreover, one or more features disclosed herein with reference to one figure or embodiment can be used interchangeably with other disclosed embodiments of the invention. The accompanying claims and their equivalents are intended to cover such forms or modifications as would fall within the scope and spirit of the disclosure.

What is claimed is:

1. A system for concealing sensitive information on a sheet of paper without shredding, the system comprising:
a consumer-sized obfuscation device comprising,
a pair of rollers, at least one of the rollers having an obfuscation pattern imprinted thereon to be applied to at least one side of a sheet of paper fed therethrough,
at least one ink cartridge adjacent to the pair of rollers, the at least one ink cartridge configured to apply ink to at least one of the pair of rollers,
a housing enclosing the pair of rollers and the at least one ink cartridge,
a feed tray attached to the housing, the feed tray being configured to receive a plurality of sheets of paper;
an auto feed roller configured to sequentially advance one of the plurality of sheets of paper to the pair of rollers for application of the obfuscation pattern to at least one side of the one sheet of paper by at least one of the pair of rollers; and
a recycle bin configured to receive a plurality of obfuscated sheets of paper from the obfuscation device, the recycle bin comprising,
a bottom portion sized to receive the plurality of obfuscated sheets of paper, and
a plurality of binding members extending from the bottom portion, the plurality of binding members configured to bind the obfuscated sheets of paper in an organized bundle.

2. The system of claim 1, wherein the recycle bin is positioned within the housing of the consumer-sized obfuscation device.

3. The system of claim 1, wherein the recycle bin is comprised of recyclable material.

4. The system of claim 1, further comprising paper guides configured to guide the obfuscated sheets of paper into the recycle bin.

5. The system of claim 1, further comprising a sensor configured to detect when the recycle bin reaches a full state.

6. The system of claim 1, wherein the at least one ink cartridge comprises an application portion that is exposed to an outer surface of a respective roller and is configured to apply ink to the respective roller via direct contact as the roller rotates about a central axis.

7. The system of claim 6, wherein the application portion of the at least one ink cartridge is composed of a foam material.

8. A consumer-sized document obfuscation device configured to conceal sensitive information on a sheet of paper without shredding, the device comprising:
at least one roller engraved or embossed with an obfuscation pattern, the at least one roller being configured to apply ink to at least one sheet of paper passing in contact therewith;
at least one removable ink cartridge adjacent to the at least one roller, the at least one removable ink cartridge comprising a foam portion configured to directly contact an outer surface of the at least one roller to transfer the ink to the at least one roller;
a housing substantially enclosing the at least one roller and the at least one removable ink cartridge; and
a feed tray attached to the housing, the paper tray being configured to receive the at least one sheet of paper to be obfuscated.

9. The consumer-sized document obfuscation device of claim 8, further comprising an auto feed assembly and an auto feed roller configured to sequentially advance ones of multiple sheets of paper from the feed tray to the at least one roller.

10. The consumer-sized document obfuscation device of claim 9, further comprising at least one sensor for detecting the presence of at least one sheet of paper in the feed tray.

11. The consumer-sized document obfuscation device of claim 8, further comprising a rotatable handle on an outside of said housing and configured to advance the at least one sheet of paper by the at least one roller by manual rotation of the rotatable handle.

12. The consumer-sized document obfuscation device of claim 8, further comprising one or more paper guides configured to guide the at least one sheet of along a predetermined pathway through the device.

13. The consumer-sized document obfuscation device of claim 8, wherein the obfuscation pattern comprises alphanumeric symbols.

14. The consumer-sized document obfuscation device of claim 8, wherein the foam portion of the at least one removable ink cartridge is configured to move slightly away from the at least one roller when not in use.

15. The consumer-sized document obfuscation device of claim 8, wherein the feed tray is configured to feed the at least one sheet of paper into the device in a substantially horizontal position.

16. The consumer-sized document obfuscation device of claim 8, wherein the at least one roller comprises two rollers each engraved or embossed with the obfuscation pattern and configured to obfuscate both sides of the sheet of paper simultaneously.

17. A consumer-sized document obfuscation device configured to conceal sensitive information on a sheet of paper without shredding, the device comprising:
a pair of rollers, wherein an outer surface of at least one of the pair of rollers is engraved or embossed with an obfuscation pattern configured to apply ink to at least one sheet of paper passing in contact therewith;
at least one replaceable ink cartridge adjacent to the at least one roller, the at least one replaceable ink cartridge having an ink application portion that is exposed to the outer surface of the at least one roller and configured to apply the ink to the outer surface of the at least one roller via direct contact as the at least one roller rotates about a central axis;
a housing substantially enclosing the pair of rollers and the at least one replaceable ink cartridge;
a feed tray attached to the housing, the feed tray being configured to receive the at least one sheet of paper; and
an auto feed roller configured to automatically advance the at least one sheet of paper from the paper feed tray to the pair of rollers.

18. The consumer-sized document obfuscation device of claim 17, wherein the ink application portion is configured to move relative to the at least one roller to apply the ink to the outer surface of the at least one roller.

19. The consumer-sized document obfuscation device of claim 17, wherein the pair of rollers and the auto feed roller are configured to rotate in a synchronized manner.

20. The consumer-sized document obfuscation device of claim 17, further comprising a recycle bin positionable within the housing and configured to receive a plurality of obfuscated sheets of paper from the pair of rollers.
